(19) United States
(12) Patent Application Publication
(10) Pub. No.: US 2003/0057866 A1
(43) Pub. Date: Mar. 27, 2003

(54) Electronic ballast and lighting fixture

(75) Inventors: Koji Takahashi, Kanagawa-ken (JP); Kiyoteru Kosa, Shizuoka-ken (JP); Hiroyuki Kudo, Kanagawa-ken (JP); Kazutoshi Mita, Kanagawa-ken (JP)

Correspondence Address: PILLSBURY WINTHROP, LLP, P.O. BOX 10500, MCLEAN, VA, 22102, US

(73) Assignee: TOSHIBA LIGHTING & TECHNOLOGY CORPORATION, Tokyo (JP)

(21) Appl. No.: 10/253,528

(22) Filed: Sep. 25, 2002

(30) Foreign Application Priority Data
Sep. 25, 2001 (JP) 2001-292671

(51) Int. Cl. H05B 37/02

(52) U.S. Cl. 315/219; 315/224

(57) ABSTRACT

An electronic ballast comprises a direct current power supply configured to provide a direct current voltage, an inverter circuit for converting the direct current voltage to a high-frequency alternating current and a load circuit. The inverter circuit includes a switching element and a resonance circuit, and is connected in parallel to the direct current power supply. The resonance circuit includes a resonance inductor, a resonance capacitor, and a first winding of an electrical insulating transformer having first and second windings.

The load circuit is provided with the second winding of the electrical insulating transformer and includes, a lamp series circuit that has first and second discharge lamps, and a capacitor for detecting a direct current. Each of the first and second discharge lamps has first and second filaments, in which an end of the second filament of the first discharge lamp is connected to an end of the first filament of the second discharge lamp. Further, a second end of the second filament of the first discharge lamp is connected to a second end of the first filament of the second discharge lamp via a ground connection.

### BACKGROUND OF THE INVENTION

1. Field of the Invention

The present invention relates to an electronic ballast and a lighting fixture using the electronic ballast.

2. Description of the Related Art

An electronic ballast for a discharge lamp, including an electrical insulating transformer, is known in Japanese Laid Open Patent Application 2000-48989 (the '989 application). According to the '989 application, the electronic ballast comprises an inverter circuit having an electrical insulating transformer. A first winding of the electrical insulating transformer is connected to a direct current power supply. A load circuit is provided on a second winding of the electrical insulating transformer, and connected in parallel with a series circuit including first and second fluorescent lamps. When the load circuit electrically separates from the inverter circuit, it is advantageous for a person to avoid an electric shock. In the operation of the electronic ballast and the fluorescent lamp providing light, if a person carelessly touches the lit fluorescent lamp, or holds the fluorescent lamp to change to a new one, an electric current cannot flow into the inverter circuit via the body of the person and the

Furthermore, according to the '989 application, the load circuit further comprises a lamp life detecting means including a photodiode. A detected signal from the lamp life detecting means is supplied to an inverter control circuit including a phototransistor by the photodiode. The inverter control circuit receives the detected signal by the phototransistor because the lamp life detecting means electrically insulates from the inverter circuit. However, it is unfavorable for such an electronic ballast to use this photodiode and phototransistor circuit because the circuit is complicated and increases costs. Therefore, it is desired that the electronic ballast reduce electric current flow, and easily provide some detecting means at the same time.

Generally, an electronic ballast has some type of detecting means such as a lamp life detecting means, a lamp equipment detecting means, or lamp lighting detecting means.

The lamp life detecting means detects whether a fluorescent lamp operates normally. For example, when one filament of a fluorescent lamp is almost dead, a discharge current of the fluorescent lamp flows almost one way from the other filament to the dead filament. In this case, a direct current voltage generates between the pair of filaments of the fluorescent lamp. The lamp life detecting means detects this voltage, and knows whether the fluorescent lamp is operating normally.

The lamp equipment detecting means detects whether a fluorescent lamp is properly mounted on a lamp socket. When the fluorescent lamp is not properly installed on the lamp socket, its load circuit can not suitably operate, and the inverter control circuit stops the output of the inverter.

Finally, the lamp lighting detecting means knows whether a fluorescent lamp lights by detecting a lamp voltage of the fluorescent lamp. When the fluorescent lamp normally lights, the lamp voltage is a low level.

### SUMMARY OF THE INVENTION

According to one aspect of the invention, an electronic ballast comprises a direct current power supply, producing a direct current voltage. An inverter circuit for converting the direct current voltage to a high-frequency alternating current includes a switching element and a resonance circuit, and is connected in parallel with the direct current power supply. The resonance circuit is provided with a resonance inductor, a resonance capacitor, and a first winding of an electrical insulating transformer having first and second windings.

A load circuit is provided with the second winding, a lamp series circuit including first and second discharge lamps, and a capacitor for detecting a direct current. Each of the first and second discharge lamps has first and second filaments, and one end of the second filament of the first discharge lamp is connected to one end of the first filament of the second discharge lamp. Further the other end of the second filament of the first discharge lamp is connected to the other end of the first filament of the second discharge lamp, and has a ground connection.

According to another aspect of the invention, a lighting fixture comprises a body; lamp sockets, and an electronic ballast.

These and other aspects of the invention will be further described in the following drawings and detailed description of the invention.

### BRIEF DESCRIPTION OF THE DRAWINGS

The invention will be described in more detail below by way of examples illustrated by drawings in which:

FIG. 1 is a circuit diagram of an electronic ballast according to a first embodiment of the present invention;

FIG. 2 is a perspective view of a lighting fixture using the first embodiment;

FIG. 3 is a circuit diagram of an electronic ballast according to a second embodiment of the present invention;

FIG. 4 is a circuit diagram of an electronic ballast according to a third embodiment of the present invention;

FIG. 5 is a circuit diagram of an electronic ballast according to a fourth embodiment of the present invention; and

FIG. 6 is a circuit diagram of an electronic ballast according to a fifth embodiment of the present invention.

### DETAILED DESCRIPTION OF SEVERAL EMBODIMENTS OF THE INVENTION

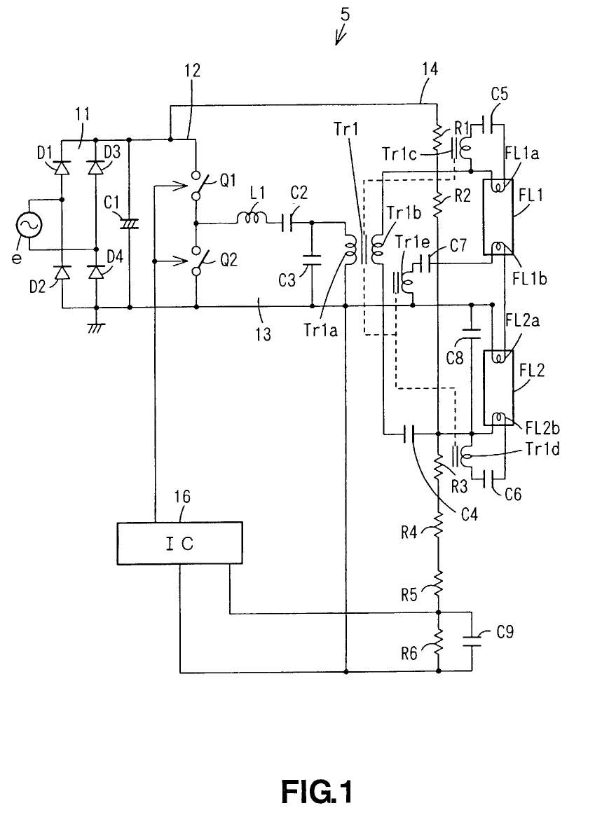

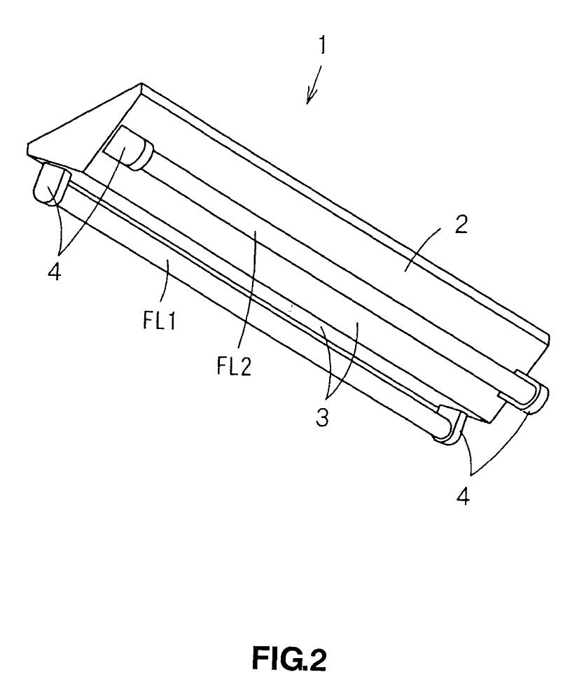

A first embodiment of the present invention will be described in detail with reference to FIG. 1 and FIG. 2.

FIG. 2 shows a perspective view of a lighting fixture using a first embodiment of the electronic ballast of the present invention. The lighting fixture 1 is provided with a body 2, having a reflecting surface 3, and lamp sockets 4, arranged at opposite ends of the reflecting surface 3. Discharge lamps or first and second fluorescent lamps FL1, FL2 are electrically and mechanically set between the lamp sockets 4. The fluorescent lamps FL1, FL2 are lit by an electronic ballast 5 (not shown in FIG. 1), commodated in the body 2.

FIG. 1 shows a circuit diagram of the electronic ballast according the first embodiment of the present invention. The electronic ballast 5 comprises an alternating current power supply (e), direct current power supply or a full-wave rectifier 11, including four (4) diodes D1, D2, D3 and D4. The full-wave rectifier 11 is connected in parallel with a smoothing capacitor C1. Furthermore, a half-bridge inverter circuit 13, including a series circuit 12 of switching elements Q1, Q2 is connected in parallel with the smoothing capacitor C1. The switching elements Q1, Q2 may be field-effect transistors.

The half-bridge inverter circuit 13 is provided with a series resonance circuit including an inductor L1, a capacitor C2 for resonance, and a first winding Tr1a of an electrical insulating transformer Tr1. A second winding Tr1b of the transformer Tr1 is connected to one end of a first filament FL1a of the first fluorescent lamp FL1 at its one end. The other end of the second winding Tr1b is connected to one end of a second other end of the second fluorescent lamp FL2 via a capacitor C4 for cutting off direct current.

The first filament FL1a is further connected in parallel with a series circuit, including a third winding Tr1c and a capacitor C5 for preheating the first filament FL1a. The second filament FL2b is also connected in parallel with a series circuit, including a fourth winding Tr1d and a capacitor C6 for preheating the second filament FL2b. Furthermore, one end of a second filament FL1b of the first fluorescent lamp FL1 is connected to a series circuit including a fifth winding Tr1e and a capacitor C7 for preheating the second filament FL1b. The other end of the second filament FL1b is connected to one end of a first filament FL2a of the second fluorescent lamp FL2. The other end of the first filament FL2a has a ground connection. That is, the other end of the first filament FL2a is connected to a negative side of the full-wave rectifier 11. A sequential capacitor C8, which controls the initial current flow to fluorescent lamps FL1, FL2, is connected between the filaments FL2a and FL2b.

A lamp lighting detecting means or a voltage supplying means 14 comprises a series circuit including resistors R1 and R2.

A voltage detecting circuit, including resistors R3, R4, R5 and R6 is connected between the negative side of the full-wave rectifier 11 and the capacitor C4, and detects a voltage value of the capacitor C4. Furthermore, the resistor R6 is connected in parallel with a capacitor C9. As such the parallel circuit operates as a filter to remove a part of a alternating current. A controller IC (Integrated Circuit) 16 controls the switching elements Q1, Q2 according to an output signal of the parallel circuit including the resistor R6 and the capacitor C9.

An operation of the above-mentioned electronic ballast 5 will be explained hereinafter. A direct current voltage from the full-wave rectifier 11 is supplied to the smoothing capacitor C1 when the alternating current power supply (e) is turned on. The direct current voltage is smoothed by the smoothing capacitor C1 and is supplied to the half-bridge inverter circuit 13. The controller IC 16 alternately controls the operation of switching elements Q1, Q2. That is, each switching element Q1, Q2 alternately turns on and off. And, the half-bridge inverter circuit 13 generates a high-frequency alternating current on the first winding Tr1a of the transformer Tr1.

When the second winding Tr1b of the electrical insulating transformer Tr1 generates an induced voltage, the windings Tr1c, Tr1d, and Tr1e start to preheat each filament FL1a, FL1b, FL2a, and FL2b of the fluorescent lamps FL1 and FL2. As depicted in FIG. 1, the first filament FL1a of the first fluorescent lamp FL1 is preheated by the third winding Tr1c, and the second filament FL2b of the second fluorescent lamp FL2 is preheated by the fourth winding Tr1d. Further, the second filament FL1b of the first fluorescent lamp FL1 and the first filament FL2a of the second fluorescent lamp FL2 are preheated by the fifth winding Tr1e respectively. The capacitors C5 to C7 may be used to adjust the preheating voltage.

After the filaments FL1a, FL1b, FL2a and FL2b are preheated the first fluorescent lamp FL1 starts to light before the second fluorescent lamp FL2 lights because the second fluorescent lamp FL2 is connected in parallel with the capacitor 8.

In the embodiment of FIGS. 1 and 2, when both fluorescent lamps FL1, FL2 are operating normally, the direct current flows in a path including the smoothing capacitor C1, the voltage supplying means 14, the second fluorescent lamp FL2, and the smoothing capacitor C1. During lamp operation, the impedance of the fluorescent lamps FL1 and FL2 is smaller than that of resistor R6. Thus, as the voltage value of the resistor R6 does not increase, the controller IC 16 can ordinarily operate to control the switching elements Q1 and Q2.

In a scenario in which the second fluorescent lamp FL2 does not operate properly or light, the impedance of the second fluorescent lamp FL2 becomes higher than that of resister R6. This, in turn, causes the current from the smoothing capacitor C1 to flow in a path including the voltage supplying means 14, and resistors R3, R4, R5, and R6. As the voltage value of the resistor R6 rises, the controller IC 16 senses the failure of the lamp lighting, and controls the switching elements Q1 and Q2 so as to reduce or stop the high frequency alternating current of the half-bridge inverter circuit 13. Therefore, the switching elements Q1 and Q2 are protected.

Because the end of the first filament FL2a of the second fluorescent lamp FL2 has a ground connection, it is advantageous for a person to avoid an electric shock. In the case of the electronic ballast operating and the lamp lighting, if a parson carelessly touches the fluorescent lamp, or holds the fluorescent lamp to change to a new one, the person hardly feels any electric shock. For example, when both fluorescent lamps FL1, FL2 normally operate, a voltage of about 200V may be supplied to its lamp series circuit. Therefore, a voltage of about 100V is supplied to each lamp, because the connecting point of both filament FL1b and FL2a is connected to the ground or the negative side of the direct current power supply. According to the embodiment, the electronic ballast reduces the electric current, and easily provides some detecting means to determine whether a fluorescent lamp is operating properly.

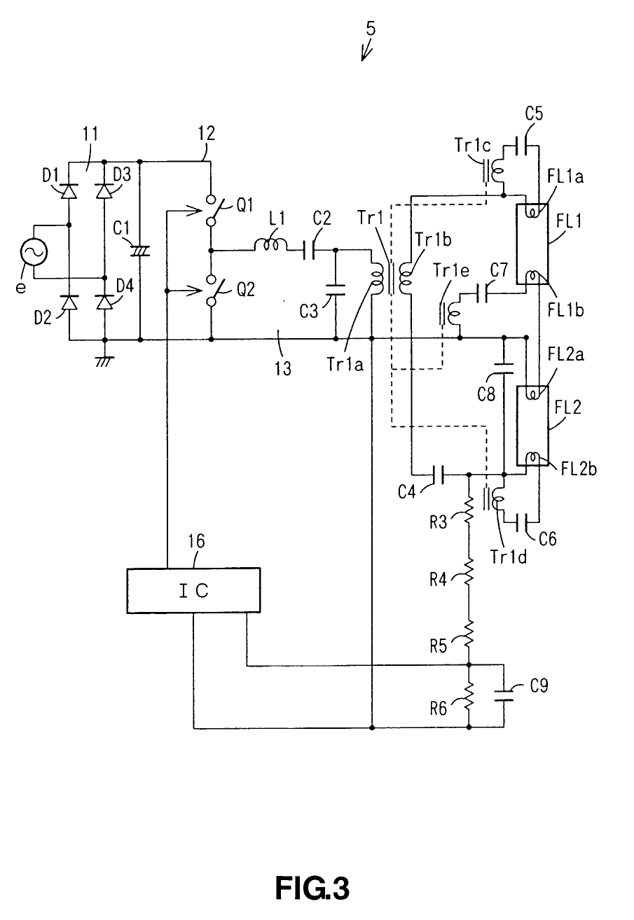

FIG. 3 shows a circuit diagram of an electronic ballast according to a second embodiment of the present invention. In this embodiment the electronic ballast shown in FIG. 1 is not provided with a voltage supplying means 14. Similar reference characters designate identical or corresponding elements of the first embodiment. Therefore, detail explanations of the structure will not be provided.

A lamp voltage detecting circuit, including resistors R3, R4, R5 and R6, is connected between a negative side of a full-wave rectifier 11 and a capacitor C4, and detects a voltage value of the capacitor C4. Furthermore, the resistor R6 is connected in parallel with a capacitor C9. A controller IC (Integrated Circuit) 16 controls the switching elements Q1, Q2 according to an output signal of the parallel circuit including the resistor R6 and the capacitor C9.

An operation of the above-mentioned electronic ballast 5 will be explained hereinafter. In this embodiment, when first and second fluorescent lamps FL1, FL2 operate normally, a high frequency alternating current is supplied to a load circuit including both fluorescent lamps FL1, FL2. In this case, the high frequency alternating current does not charge the capacitor C4 to cut off the direct current flow. However, when the first fluorescent lamp FL1 operates normally and the second fluorescent lamp FL2 is almost dead, a discharge current of the second fluorescent lamp FL2 mainly flows one way from one filament to the other dead filament.

In this case, a direct current voltage generates between the pair of filaments of the second fluorescent lamp FL2. Thus, the capacitor C4 is charged by the direct current voltage generated between the pair of filaments FL2a and FL2b. As the voltage of the capacitor C4 increases, the voltage of the resister R6 also rises. The voltage value of the resister R6 permits the controller IC 16 to sense any unusual lamp lighting. In response, the controller IC 16 controls the switching elements Q1 and Q2 to reduce or stop the high frequency alternating current of the half-bridge inverter circuit 13. Therefore, the switching elements Q1 and Q2 are protected.

According to the above embodiment, the electronic ballast reduces current flow, and easily provides a detecting means to determine whether a fluorescent lamp is operating properly.

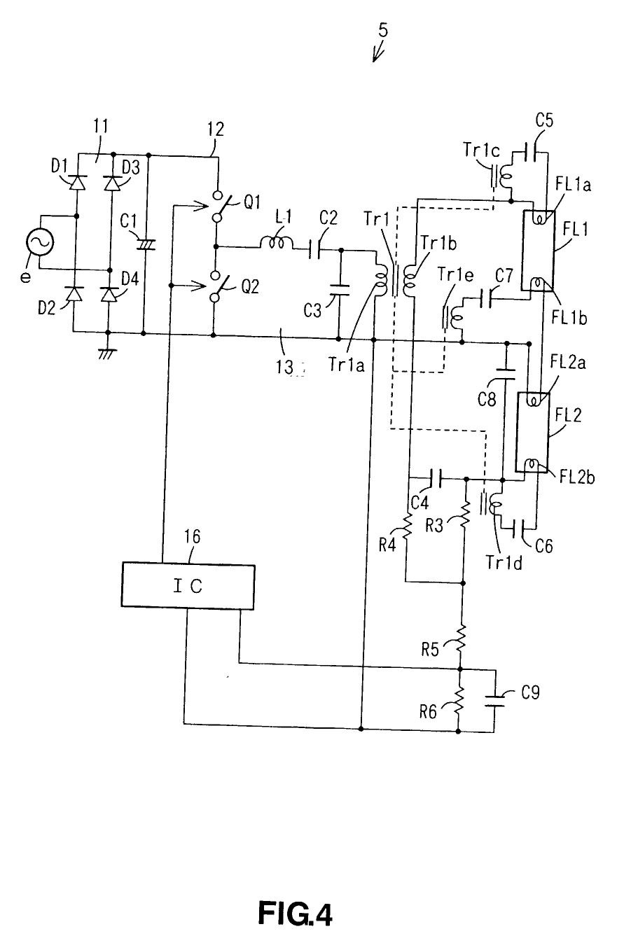

FIG. 4 shows a circuit diagram of an electronic ballast according to a third embodiment of the present invention. In this embodiment, a resistor R4 has a different connection compared with the first and second embodiments. That is, the resistor R4 is connected in parallel with a resistor R3 via a capacitor C4. Similar reference characters designate identical or corresponding elements of the second embodiment. Therefore, detail explanations of the structure will not be provided.

In this embodiment, when first and second fluorescent lamps FL1, L2 operate normally, a high frequency alternating current is supplied to a load circuit including both fluorescent lamps FL1, FL2. Therefore, the high frequency alternating current does not charge in the capacitor C4. However, when the first fluorescent lamp FL1 is operating normally and the second fluorescent lamp FL2 is almost dead, a discharge current of the second fluorescent lamp FL2 mainly flows one way from one filament to the other dead filament.

As a result, a direct current voltage is generated between the pair of filaments FL2a and FL2b of the second and the fluorescent lamp FL2, and the capacitor C4 may charge by the generated direct current voltage. As the voltage of the capacitor C4 increases, the voltage of the resister R6 also rises. The voltage value of the resister R6 permits the controller IC 16 to detect unusual lamp lighting. Based upon whether the lamp lighting is functioning properly, the controller IC 16 controls the switching elements Q1 and Q2 to reduce or stop the high frequency alternating current power output of the half-bridge inverter circuit 13. Therefore, the switching elements Q1 and Q2 are protected.

In a scenario in which the second fluorescent lamp FL2 operates normally and the first fluorescent lamp FL1 is almost dead, a discharge current of the first fluorescent lamp FL1 mainly flows one way from one filament to the other dead filament. In this case, a direct current voltage is generated between the pair of filaments FL1a and FL1b of the first fluorescent lamp FL1, and the capacitor C4 may be charged by as the direct current voltage generated between the filaments FL1a and FL1b. As the voltage of the capacitor C4 increases, the voltage across the resistor R6 also rises. The voltage value of the resistor R6 lets the controller IC 16 to detect any unusual lamp lighting. In response, the controller IC 16 controls the switching elements Q1 and Q2 to reduce or stop the power output of the half-bridge inverter circuit 13.

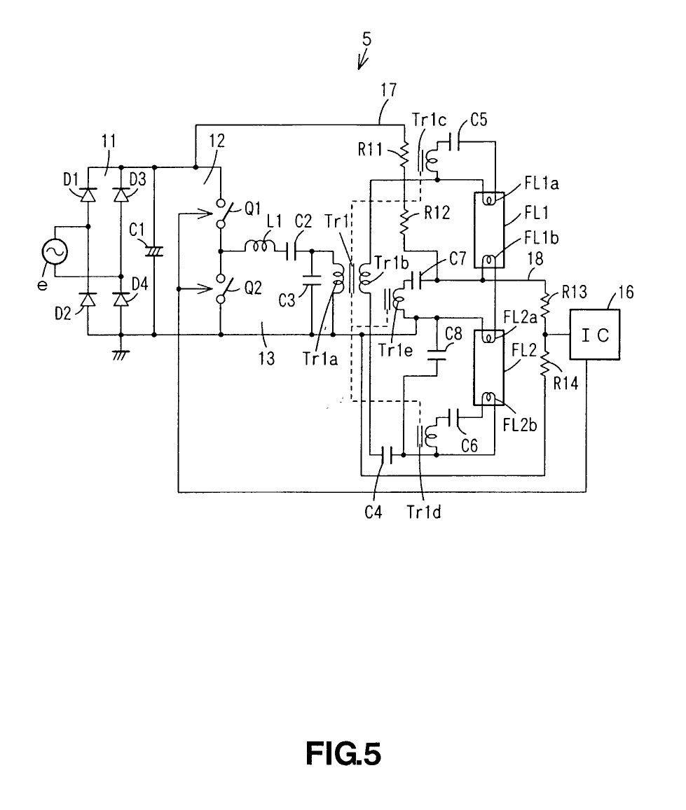

FIG. 5 shows a circuit diagram of an electronic ballast according a fourth embodiment of the present invention. Similar reference characters designate identical or corresponding elements of the first embodiment. Therefore, detail explanations of the structure will not be provided.

In this embodiment, a lamp equipment detecting means includes a direct current flowing circuit 17 and a current detecting means 18. The direct current flowing circuit 17, which is provided with a series circuit including resistors R11 and R12, a second filament FL1b of a first fluorescent lamp FL1, and a first filament FL2a of a second fluorescent lamp FL2, is connected in parallel with a smoothing capacitor Cl instead of the voltage supplying means 14 shown in FIG. 1. The current detecting means 18, including a series circuit of resistor R13 and R14, is connected in parallel with the series circuit including the second filament FL1b and the first filament FL2a. Furthermore, a controller IC 16 is connected between resistors R13 and R14.

Operation of the fourth embodiment of the electronic ballast will be explained hereinafter. In FIG. 2 when the fluorescent lamps FL1 and FL2 are mounted to the lamp sockets 4 without fail, a current mainly flows in the path including the smoothing capacitor C1, the resistor R11 and R12, the second filament FL1b of the first fluorescent lamp FL1, the first filament FL2a of the second fluorescent lamp FL2, and the smoothing capacitor C1. Since a total resistance value of the second filament FL1b and the first filament FL2a is lower than that of the resistors R13 and R14, the current hardly flows through the resistors R13 and R14, such that the voltage of the resistors R13 and R14 does not increase. Therefore, the controller IC 16 can ordinarily know the operation to control the switching elements Q1 and Q2, and the half-bridge inverter circuit 13 can start the fluorescent lamps FL1 and FL2.

When both fluorescent lamps FL1, FL2 fail to mount to the lamp sockets 4 shown in FIG. 2, the direct current flowing circuit 17 has a disconnection at the second filament FL1b or the first filament FL2a. In this case, a current from the smoothing capacitor C1 flows through a path including resistors R11, R12, R13, and R14, such that the voltage of the resistors R13 and R14 increases. Accordingly, the controller IC 16 detects failure of mounting, and controls the switching elements Q1 and reduce or stop the power output of the inverter circuit 13. Therefore, the switching elements Q1 and Q2 are protected.

According to the fourth embodiment of FIG. 5, the electronic ballast reduces the current flow, and easily provides some detecting means to determine whether the fluorescent lamps have been mounted properly.

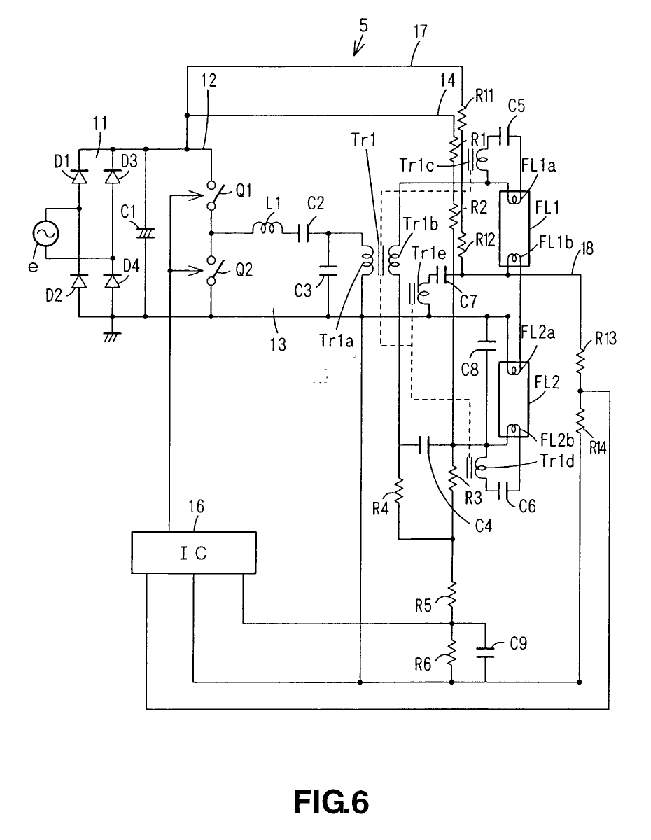

FIG. 6 shows a circuit diagram of an electronic ballast according to a fifth embodiment of the present invention. In this embodiment, the electronic ballast comprises all detecting means aformentioned first to fourth embodiments. Similar reference characters designate identical or corresponding elements of the first to fourth embodiment. Therefore, detail explanations of the structure and operation will not be provided. The structure and operation is described above. According to the fifth embodiment of FIG. 6, the electronic ballast reduces the current flow, and easily provides some detecting means.

What is claimed is:

1. An electronic ballast, comprising:
a direct current power supply configured to provide a direct current voltage;
an inverter circuit connected in parallel with the direct current power supply and configured to convert the direct current voltage to a high-frequency alternating current, the inverter circuit including a switching element and a resonance circuit, wherein, the resonance circuit is provided with a resonance inductor, a resonance capacitor, and a first winding of an electrical insulating transformer having first and second windings; and
a load circuit, provided with the second winding of the electrical insulating transformer, the load circuit including a lamp series circuit having first and second discharge lamps, and a capacitor configured to detect a direct current,
wherein each of the first and second discharge lamps has first and second filaments, and one end of the second filament of the first discharge lamp is connected to one end of the first filament of the second discharge lamp, further a second end of the second filament of the first discharge lamp is connected to a second end of the first filament of the second discharge lamp via a ground connection.

2. An electronic ballast according to claim 1, further comprising:
a lamp voltage detecting means configured to be connected between a negative side of the direct current power supply and the capacitor for detecting the direct current; and
a controller configured to control the switching element in accordance with an output signal of the lamp voltage detecting means.

3. An electronic ballast according to claim 2, further comprising:
a voltage supplying means, configured to have one end connected to a positive side of the direct current power supply and a second end connected between the capacitor for detecting a direct current and the second filament of the second discharge lamp.

4. An electronic ballast according to claim 1, further comprising
a direct current flowing circuit configured to have one end connected to a positive side of the direct current power supply and a second end connected to one end of the second filament of the first discharge lamp; and
a current detecting means configured to be connected in parallel with a series circuit including the second filament of the first discharge lamp and the first filament of the second discharge lamp; and
a controller configured to control the switching element of the inverter circuit according to an output signal of the current detecting means.

5. An electronic ballast according to claim 1, further comprising:
a lamp voltage detecting means configured to connect between a negative side of the direct current power supply and the capacitor for detecting a direct current;
a voltage supplying means configured to have one end connected to a positive side of the direct current power supply and a second end connected between the capacitor for detecting a direct current and the second filament of the second discharge lamp;
a direct current flowing circuit configured to have one end connected to a positive side of the direct current power supply and a second end connected to one end of the second filament of the first discharge lamp;
a current detecting means configured to be connected in parallel with a series circuit including the second filament of the first discharge lamp and the first filament of the second discharge lamp; and
a controller configured to control the switching element of the inverter circuit according to an output signal of the voltage detecting means and the current detecting means.

6. A lighting fixture, comprising:
a body;
lamp sockets, constructed and arranged on the body; and
an electronic ballast for a discharge lamp, comprising:
a direct current power supply configured to produce a direct current voltage;
an inverter circuit connected in parallel with the direct current power supply and configured to convert the direct current voltage to a high-frequency alternating current, the inverter circuit including a switching element and a resonance circuit, wherein, the resonance circuit is provided with a resonance inductor, a resonance capacitor and a first winding of an electrical insulating transformer having first and second windings; and
a load circuit, provided with the second winding of the electrical insulating transformer, the load circuit including a lamp series circuit having first and second discharge lamps, and a capacitor for detecting direct current, wherein each of the first and second discharge lamps has first and second filaments, and one end of the second filament of the first discharge lamp is connected to one end of the first filament of the second discharge lamp, further a second end of the second filament of the first discharge lamp is connected to a second end of the first filament of the second discharge lamp via a ground connection.
